(19) United States
(12) Patent Application Publication
(10) Pub. No.: US 2011/0054949 A1
(43) Pub. Date: Mar. 3, 2011

(54) METHOD, SYSTEM & APPARATUS FOR GENERATING DIGITALLY ENCODED ELECTRIC SIGNALS REPRESENTING A CALCULATION

(75) Inventors: Christopher Ronald Edward Joye, New South Wales (AU); Alun Lloyd Pope, New South Wales (AU)

(73) Assignee: ARES CAPITAL MANAGEMENT PTY LTD, Sydney, NSW (AU)

(21) Appl. No.: 12/864,597

(22) PCT Filed: Jan. 22, 2009
(86) PCT No.: PCT/AU2009/000069

§ 371 Date: Sep. 29, 2010

(30) Foreign Application Priority Data
Jan. 29, 2008 (AU) 2008200417

(51) Int. Cl. G06Q 40/00

(52) U.S. Cl. 705/4

(57) ABSTRACT

A method, apparatus and system for computing mortgage insurance premiums for shared equity mortgages are disclosed. Such shared equity mortgages rank behind a conventional interest bearing first mortgage and both mortgages are secured over the same property. Details of the mortgages and property are stored in the data store of a computer system. The future sale price at predetermined future dates for each property is estimated in order to calculate each possible future loss in the event that the shared equity mortgage is terminated at each future date. This information and an estimated probability of termination at each future dates are used to calculate an appropriate insurance premium.

### FIELD OF THE INVENTION

The present invention relates to a method, apparatus and system for computing mortgage insurance premiums for a new and novel suite of financial products known as shared equity mortgage insurance (SEMI). These products cover a variety of unique risks associated with a class of state-dependent hybrid debt instruments, a specific embodiment of which is known as the shared equity mortgage (SEM).

### BACKGROUND ART

### A. Lenders Mortgage Insurance (LMI)

Prior to the advent of lenders mortgage insurance (LMI), credit providers would require borrowers to have a significant deposit of at least 20% of the value of their property when buying a home. There would also typically be large “closing costs” associated with securing this financing. These safeguards were put in place to protect lenders against the risk of borrower default. That is, events whereby borrowers could not for one reason or another continue to service their interest and/or principal repayments on the loan that was extended to them.

When borrowers fail to meet their repayments lenders lose money. However, the lender's position is even more dire in events whereby the value of the asset, usually a property (which serves as the security for the finance) has fallen at the same time as the borrower has defaulted on their loan. In particular, if the value of the so-called “collateral” (ie, the asset) has fallen to such a degree that the principal sum owing under the finance (say a mortgage) is greater than the value of the security, then lenders are exposed to the risk that when they take possession of the asset (typically by foreclosing on the borrower) and seek to divest of it in the marketplace, the proceeds they realize will be insufficient to recover the full principal sum that they are owed by the borrower.

In this scenario, the lender has actually suffered two forms of loss: first, the loss associated with the lost interest repayments on the loan; and second, losses attributable to the fact that they have not been repaid the full principal amount that they originally extended to the borrower as a consequence of the decline in the value of the underlying property. To combat these risks, lenders would normally only extend finance that represented a conservative percentage of the value of the asset that serves as security. This principle applies to all forms of finance: that is, lending to corporate or individuals.

In the case of residential mortgages, lenders would, prior to the availability of LMI, typically cap their housing finance at 80% of the value of the property. The approach idea is that the value of the asset would have to decline by a somewhat unlikely (albeit not impossible) 25% prior to the lender suffering any losses on the principal amount owing under the mortgage.

Yet this is not the entire story. In addition to direct property price depreciation there are also sizeable “round-trip” transaction costs associated with the purchase and sale of residential real estate assets. In Australia, these are estimated to be as high as 12% of the value of the property. This means that in a sale of a defaulting borrower's property the asset value may only have to fall, say, 19% before the lender suffers a principal loss (ie, assuming that they originally extended finance that was worth 80% of the property's initial value).

To complicate the lender's risk position further, periods of high borrower default tend to be correlated with periods of high property price depreciation or low to zero growth. One only needs to consider the experience in the early 1990s in Australia, the US or the UK. Even more relevantly, the dynamics witnessed in the US housing market over 2007/2008 are perhaps the best recent example of the concurrence of high rates of default and large property price declines. And so while mortgage default rates in many developed countries might appear, on a long-term historical basis, to be reasonably low, and property price growth typically very strong, there tends to be a strong coincidence between the timing of significant increases in defaults and precipitous property prices declines. Of course, the common denominator here is often interest rates, although this is not always the case. In the US during 2007/2008 high rates of mortgage default actually materialized independently of high interest rates and in turn precipitated falling property prices. Indeed, if one were to casually inspect the empirical data one would observe the coincidence of falling interest rates, unusually high levels of mortgage default, and dramatic declines in the value of residential real estate.

Lenders mortgage insurance (LMI) seeks to address many of these risks for lenders. More specifically, this form of insurance protects lenders in the event that their borrowers default and usually covers both the foregone interest repayments and any losses on the principal loan amount (subject to the limits of the coverage set forth in the insurance policy). Since the risk of borrower default is in effect being transferred from the lender to the insurer, the providers of LMI are very careful to review the credit risk profile of the borrower in advance of providing the insurance. In contrast to most other forms of insurance, the cost of LMI is usually, but not always, paid for by the beneficiary of the finance and prospective trigger for the risk (ie, the borrower) rather than the beneficiary of the insurance itself (ie, the lender) in a somewhat atypical reversal of the relationships conventionally found in these markets. This is, however, not always the case, and it is quite common in securitized transactions (see below) and circumstances where the borrower's “loan-to-value” (LVR) is low for the beneficiaries of the insurance (ie, lenders and investors) to also burden its cost.

In the US, early forms of LMI arose around the turn of the 20^{th} century and developed until the emergence of the Great Depression in 1929. Up until this point, rising real estate values meant that mortgage insured properties that were in default could be sold without usually being subject to a loss. This led to the belief that providing LMI was a low risk business—much like similar views that had prevailed during the late 1990s and early 2000s prior to the so-called “sub-prime” crisis.

As a result of the Great Depression, the private LMI industry collapsed and the US Federal Government assumed responsibility for providing LMI until the late 1950s. In the 1950s and 1960s private mortgage insurers began to emerge in the US, Australia and the UK. The first such provider to commence operating in the US was the Mortgage Guarantee Insurance Corporation (MGIC). Today one now finds mature LMI markets in the US, UK, Australia, NZ and Canada with more nascent industries developing in Germany and France.

In Australia, LMI is usually required for all loans with a total LVR ratio of greater than 80%. That is, mortgages which are greater than 80% of the value of the borrower's home. The cost of LMI is usually quite high and typically is around 1% to 2% of the value of the amount borrowed.

The emergence of LMI has conferred major benefits on both borrowers and lenders. For the lenders, it shifts the risk of mortgage default to highly “rated” (in a credit respect) external parties. In addition, most “securitizations”, which is the process by which pools of mortgages are sold by lenders to third-party investors, require LMI as a condition precedent to the purchase of the loans. Securitization in and of itself has profoundly changed the way lenders around the world carry out their business and, as a consequence, the dynamics of the housing finance market. By taking mortgages off a lender's balance sheet and selling those loans to external investors, the lender is able to free up its balance sheet capacity to engage in a new round of lending. This has therefore dramatically expanded and diversified the sources of mortgage funding available to potential providers. Heightened competition on the supply-side of the mortgage finance equation has in turn delivered cost savings to end-user borrowers.

Borrowers have also benefited in many other ways. The presence of LMI has allowed lenders to offer higher LVRs that far exceed the 80% levels that existed in the pre-LMI days. Today it is not unusual to see many borrowers taking out 95%, 100% or even 100% plus loans in order to acquire the property of their dreams. According to many observers, the significant improvements in the availability, cost and flexibility of housing finance have had knock-on effects, such as elevating home ownership levels and assisting with the modern day political aspiration of creating a “property-owning democracy”.

LMI has also enabled the provision of housing finance to households with unusual or adverse credit histories. Without LMI these borrowers would struggle to secure any finance. Yet with the safeguards afforded by the introduction of LMI lenders have felt more comfortable extending finance to consumers with riskier credit profiles.

FIG. 1 is a flow chart that visually portrays how the conventional mortgage market works in the context of LMI. Under Step 1, borrowers approach a broker with an interest in obtaining traditional interest-bearing mortgage finance. Under Step 2, the broker will assist the borrower apply for a loan with the lender of their choice, such as Adelaide Bank. In Step 3 the lender processes the loan application and, depending on the characteristics of the loan (eg, whether the LVR is greater than 80%) may seek mortgage insurance on the loan from a mortgage insurer such as PMI. If the loan is approved by the lender, they will fund the finance through either their own balance sheet capacity, or via a warehouse facility provided by a third-party. Finally, in Step 4, if the lender does not wish to retain the loan on its balance sheet it can sell the loans to external investors through the process of securitization. These investors may require additional mortgage insurance on a portfolio-wide basis (eg, not just for loans with LVRs greater than 80%), in which case the mortgage insurer has a role to play here too.

### B. Shared Equity Mortgages (SEMs)

The present applicant developed the first private sector “shared equity” mortgage, known as the Equity Finance Mortgage (EFM), to ever be made available in the Australian market (see PCT/AU2005/001586 published under WO2006/105576).

The EFM is a new development in the housing finance landscape with the potential to revolutionize the way consumers think about home ownership.

Rismark's EFMs are “white-labelled” via leading retailers such as Adelaide Bank, which brand and distribute the product on Rismark's behalf. In mainland Australia today, EFMs are available in almost every metropolitan area and hundreds of families have availed themselves of this unique opportunity to either purchase a better home or dramatically reduce their repayments.

Under an EFM, the lender receives a share in the capital gains or capital losses on the home owner's property instead of charging a normal interest rate. This means that there are no repayments required whatsoever until the borrower decides to repay the entire EFM amount at any point over its 25 year term.

The EFM cost of capital (ie, the return that the lender ultimately realizes, which is paid for by the borrower) is radically different to the “interest rate” charged on any traditional debt product, such as a home loan. In order to understand how the EFM contrasts so starkly with traditional debt products it is useful to cast into sharp relief the difference between conventional forms of “interest” and the EFM cost of capital.

The essential, defining characteristic of “interest” is that it is a “time-dependent” cost of capital; that is, the variable or fixed cost on the loan accrues for as long as the borrower holds the finance (ie, over months, years etc). Now this interest can be serviced by the borrower regularly over time—as with traditional mortgages—or capitalized as in the case of a so-called “reverse mortgage”. The latter product is a relatively recent innovation in the mortgage market that is typically only offered to asset-rich yet cash-poor retirees who want to release equity from their home.

Under an EFM, no interest rate is charged and there are no repayments required whatsoever until the borrower elects to discharge the loan. Most importantly though, the cost of the EFM has nothing to do with “time”—or, more specifically, the time over which the finance is held. That is to say, the borrower can have an EFM for 3 years, 13 years or 25 years, and the total cost of the EFM may be zero, positive or negative, depending exclusively on the performance of the underlying collateral asset (namely, the borrower's residential property). The EFM cost, in the technical lexicon, is therefore “state-dependent”; ie, tied to the state of the underlying property and it is categorically not time-dependent, as is the case with conventional “interest”.

Another key differentiating attribute of the EFM cost is the fact that it may be positive, negative, or absent altogether. There is no precedent for any traditional interpretation of “interest” as involving a negative cost. That is, a “negative interest rate”. Yet under the EFM, if the value of the property falls, that is precisely what can occur: ie, the amount that the borrower repays to the lender is less than the sum that the lender originally advanced to them, to say nothing of the fact that the borrower has also not paid any periodic interest repayments during the term of the loan. Put differently, there is, in such situations, a value transfer from the lender to the borrower, not the other way around.

In addition, there are many normal contingencies under the EFM whereby the total direct cost of the product will be equal to zero: that is, the EFM will have been a costless form of finance (ignoring altogether for the moment that the borrower may have saved up to 30% or more off their traditional mortgage repayments—ie, the loan that is used in conjunction with the EFM). All that needs to happen for EFM cost to be equal to zero is that the property's value remains the same.

As we have seen throughout Australia during the period 2004 to 2006, there are countless examples in major metropolitan areas where property prices either fall precipitously or do not rise at all over many years. Accordingly, when the EFM borrower enters into the loan they can have no clear expectation of whether the product's ultimate cost will be negative, zero or positive, as it is not possible to accurately forecast future property movements.

Indeed, this is especially true at the individual home owner level. One of the common mistakes that commentators and even economists make is to impute the risk profile of a broad-based property index to that of the individual owner-occupier. Yet the index represents the price movements of an incredibly well diversified portfolio property worth literally hundreds of billions of dollars. Home owners, by way of contrast, own one property, situated on one street, with all of its manifest peculiarities. The risk of sudden positive or negative price changes is therefore far greater at the individual asset level than that which one observes when measuring the variation of a broad-based index. More technically speaking, when one calculates the long-term volatility of, by way of example, Australian residential real estate returns, the standard deviation tends to be around 5-8%. Since this is significantly less than the volatility of other major asset-classes, such as equities, commentators often conclude that bricks and mortar is the ultimate low-risk investment. Yet when one then measures the risk attributable to an individual home one finds that its volatility is around 2-3 times greater than that of the index. This places the risk of owner-occupied property broadly in line with that of equities and therefore leads one to dramatically different conclusions about its relative safety.

The risk-management characteristics of the EFM illuminates one of its key design features: it delivers a much stronger alignment of interests between the lender and the borrower. If and only if the borrower does well, and the value of their homes rises, does the lender earn a return. If, on the other hand, the borrower does badly, and the value of their home falls or does not rise, the lender also suffers, to the point where it may end up making a financial value transfer to the borrower (and not the other way around).

Since the EFM offers a range of risk-management benefits to borrowers by protecting them in situations where they suffer adverse financial circumstances (giving rise to a zero or negative cost) one cannot actually compare its cost directly with that of a traditional interest-bearing product.

In considering the cost of the EFM it is tempting for one to try and calculate an “effective interest rate” by making assumptions about future property price growth rates. Yet this deterministic analysis completely ignores the critical risk-management protections of the product: ie, the fact that all borrowers are exposed to significant “uncertainty” when they buy a home, and if property prices do not rise, or heaven forbid, fall, the cost of the EFM will be radically different to any traditional interest-bearing product. As we will see, this has important consequences for the risks to which EFM lenders are exposed, which contrast strikingly with those risks that are normally imputed to mortgage lenders.

While there have been private and public sector “shared appreciation” mortgages (SAMs) developed in the US and UK before, none of these products resulted in the lender assuming the risk of capital loss on the borrower's underlying property. If they did, they would have been termed as shared appreciation and depreciation mortgages (or SADMs).

### C. Other Hedging Mechanisms

It will be seen that the development of shared equity mortgage products opens up the possibility of entirely unprecedented and quite unique insurance instruments that can be designed to mitigate or eliminate the range of risks borne by the funders of this new form of finance.

In considering the related prior art it is useful to acknowledge recent innovations in derivative and futures markets. Since 2004 there have been a number of new exchange-traded and “over-the-counter” (OTC) derivatives and futures markets that have emerged which enable participants to more efficiently trade residential real estate risk. In particular, significant OTC property markets have developed in the UK and US with more nascent industries starting to garner momentum in Australia, Hong Kong, Japan, France and Germany. Typically, participants will use a broad-based property price index to proxy for the underlying asset-class and then exchange financial instruments based on these indices.

In recent times the most common transactions have been “total return swaps” whereby an investor that wants to hedge property risk will “sell” a notional exposure of, say, $100 million by paying the buyer of that risk the index returns multiplied by the notional sum (in this case, $100 million) for the term of the contract. In exchange, the buyer will pay the seller a fixed interest rate on the value of the notional sum. In this way, the seller of the risk is able to secure a constant return on their $100 million property exposure irrespective of what happens to the value of the underlying assets while the acquirer of the risk gets very cost-effective and well diversified access to the asset-class returns (as represented by the index) without actually having to go out and buy the physical assets.

Along similar lines, the Chicago Mercantile Exchange commenced trading residential real estate futures contracts in May 2006 on 10 US cities. These contracts are written over the performance of house price indices that proxy for the US cities in question. They provide investors with similar trading opportunities to those afforded by the OTC derivatives outlined above: that is, one can go short or long in the asset-class by trading the futures contracts while avoiding all of the transaction costs that typically plague residential real estate investments.

Although exchange-traded and OTC property derivatives are undoubtedly important capital markets innovations, they can in no way substitute for direct shared equity mortgage insurance.

### Risks

Almost all risks are theoretically insurable, although in practice commerce has only anticipated and sought to insure a finite number of them. Shared equity products, in which the financier is critically exposed to changes in the capital gains and capital losses realised by the underlying collateral assets (ie, typically a residential property), carry with them a unique, albeit imminently insurable, cohort of risks. A summary of these key risks includes, but is not limited to:

(1) the risk of capital loss: ie, whereby the asset experiences capital depreciation. If the risk of capital loss can be estimated, the premium for appropriate insurance coverage priced, and germane insurance products originated, then SEM providers can insulate themselves from such hazards;
(2) the risk of long borrower holding periods: all other things being equal, the rate of return on some SEM products can fall as a function of how long the consumer holds on to the loan or lives in their home. This contrasts directly with all other debt products wherein lenders typically benefit from longer holding periods. If the risk of long borrower holding periods can be estimated, the premium for appropriate insurance coverage priced, and germane insurance products originated, then SEM providers can insulate themselves from such hazards;
(3) the risk of moral hazard: since the lender under a SEM is sharing in the capital gains delivered by the residential property, the borrower and owner of that property has a clearly diminished exposure to its growth. This, therefore, raises the risk that the borrower under a SEM will behave differently to a typical home owner that retains 100% of the upside in their property. More particularly, the design of the SEM product begs the question as to whether in the face of diminished upside incentives the borrower will reduce their maintenance and property management activities (eg, renovations and improvements) and thereby attenuate the growth experienced by the home and hence the returns realised by the SEM lender. If the risk of moral hazard can be estimated, the premium for appropriate insurance coverage priced, and germane insurance products originated, then SEM providers can insulate themselves from these dangers;
(4) the risk of adverse gaming: to the extent that SEM borrowers have, for one reason or another, a (perhaps improbable) ability to accurately predict the future price movements associated with their homes, they could draw on SEM finance at the peak of the property cycle and then seek to repay the SEM at that future state of nature where they believe the property market is likely to recover. In this way, they will have minimized the SEM cost of capital. Indeed, if they could perfectly time the market, a SEM product with the Equity Finance Mortgage (EFM) characteristics described above (ie, a 25 year loan in which the lender shares in the property's gains and wears losses, with no interest rate charged, and no early prepayment penalties) could result in situations where borrowers pay no cost at all for the term that they held the SEM (ie, if there has been no capital growth recorded during that period) or, in an even more dire outcome for the SEM lender, pay a “negative cost” in situations where property prices have fallen: ie, the lender actually transfers the borrower value and not the other way around. If the risk of adverse gaming can be estimated, the premium for appropriate insurance coverage priced, and germane insurance products originated, then SEM providers can insulate themselves from such hazards;
(1) the risk of borrower default: the SEM is especially unusual insofar as there are no periodic interest repayments required on the loan. This means that a borrower cannot default on the SEM in the same way that borrowers normally would with any other form of debt finance—ie, by missing their monthly repayments. Yet there are still a range of potential default events under a SEM, including, but not limited to:
(a) failing to repay the total amount owing under the loan when it is eventually due for repayment (eg, upon the property being sold or the end of the loan term, which, in the EFM example above, would be 25 years);
(b) failing to have adequate insurance coverage on the property, which is essential to protecting the SEM lender's interests;
(c) failing to occupy the property as a principal-place-of-residence, as is required under the EFM product; and
(d) failing to maintain the asset in a reasonable state of repair (most loan agreements have an “as-is” clause which requires that the borrower ensures that the property is maintained in a condition that is at least as good as when the finance was originally extended).

If the risk of borrower default can be estimated, the premium for appropriate insurance coverage priced, and germane insurance products originated, then SEM providers can insulate themselves from such hazards.

Importantly, almost all of the risks outlined above are entirely unique to the SEM class of products and are not found in a conventional mortgage. This is particular true of risks (1), (2), (3), and (4). These risks may, therefore, call for an equally unique class of insurance products to adequately mitigate them.

There is another key risk that is quite peculiar to some types of SEMs and arises in ensuring that the EFM “synergistically” interacts with other mortgage products.

The maximum EFM LVR was deliberately limited to 20% of the value of the property. Under the EFM terms, this means that the lender is entitled to 40% of the potential capital growth when the borrower eventually decides to repay the loan, or the lender may wear 20% of the potential capital losses if the borrower sells their home and it declines in value. One of the reasons the LVR was limited to 20% was to ensure that the home owner always retained the vast bulk of the upside in their property, thereby giving the maximum incentive to optimize its futures growth and hence diminish the risk of moral hazard as described in risk number (3) above.

Since borrowers can only obtain finance for 20% of the value of their properties under the EFM, they must also typically draw on a traditional mortgage. In the Australian market the average mortgage LVR is around 70%. This means that borrowers would usually use a 50% normal interest-bearing home loan in conjunction with a 20% EFM.

This then raises the question as to how the EFM sits in the household's capital structure: that is, does it “rank” (1) ahead of the normal interest-bearing home loan; (2) the same as the normal interest-bearing home loan (also referred to in the capital markets lexicon as “parri-passu”), or (3) behind the normal interest-bearing home loan (known as a “second-ranking” or “subordinated” security)?

The EFM should not rank ahead of the traditional mortgage because traditional lenders would not accept any form of subordination. Mortgage lenders are heavily regulated by government bodies and subject to strict capital requirements depending on the perceived security of the loan. Subordination would expose lenders to far harsher regulation. In addition, investors that buy interests in securitized pools of mortgages normally insist that they are “prime” or first-ranking securities. Even the so-called “sub-prime” home loans are almost always first-ranking mortgages.

In short, if the EFM was a first-ranking security the borrower would find it terribly difficult to secure any other form of finance, thereby destroying the market demand for the EFM.

If, on the other hand, the EFM ranked behind the traditional mortgage, the first-ranking lender would be protected. Indeed, the EFM would be no different in the lender's eyes to the home owner's equity or the deposit in their property. In this scenario, traditional lenders would be likely to positively embrace the EFM since it would not pose any threat to their security position. In fact, if by offering the EFM alongside their conventional mortgage products these lenders were able to attract new customers that might not have previously gravitated towards them, well then it could be a very desirable option indeed.

While the subordination of the EFM to the normal first-ranking home loan is a great outcome for the traditional lender, it exposes the EFM provider to a new range of risks. In particular, over and above risks (1) through (5) identified above, the EFM lender would now be subject to the risk of the borrower defaulting on not just the EFM, but also, and quite independently, on their traditional mortgage. This in turn meant that the EFM lender was now exposed to all of the traditional debt risks (ie, credit default) in addition to the class of risks that are unique to SEM products.

The reason default on the senior interest-bearing home loan is such a concern for the EFM lender is because the senior mortgagee (ie, the senior lender that advanced the traditional interest-bearing finance in the first place) has a right under any event of default to repossess the home and dispose of it as it pleases. And since the senior lender will only have finance outstanding worth between, say, 50% and 80% of the value of the property in question (given that the EFM will usually account for the next 20%), the first ranking lender will not care what value they sell the home for so long as they recover their principal sum. This means that they would be indifferent to selling the property for, say, between 50% and 80% of its true market value just as long as they get their principal amount back (irrespective of the losses suffered by the EFM provider).

It should be easy to see then that the EFM lender is exposed to profound risks if the EFM is subordinated to a traditional mortgage provider and the borrower defaults on their repayments on the first-ranking security. In such cases, the EFM lender faces the spectre of being wiped out completely (ie, losing 100% of the EFM loan amount), particularly if these is a coincidence between the timing of borrower default and periods of property price depreciation.

With this new and unique form of risk to which the SEM class of products, and the EFM as one practical example, are exposed, an equally new set of instruments, methods and systems must be created via which the said risks can be measured, quantified, the premium for appropriate insurance coverage priced, and germane insurance products originated, so that SEM lender can adequately insure away such hazards.

In summary, the range of risks unique to SEM products include, but are limited to:

(1) the risk of the SEM lender suffering a capital loss (ie, when the SEM has been repaid and the value of the asset has fallen);
(2) the risk of the SEM lender realising no return (ie, when the SEM has been repaid and the value of the asset has not risen);
(3) the risk of the SEM lender suffering inferior returns because the SEM has been held by borrowers for an unusually long period of time;
(4) the risk of the SEM lender suffering inferior returns because of moral hazard (see the more detailed description above);
(5) the risk of the SEM lender suffering inferior returns because of adverse gaming (see the more detailed description above);
(6) the risk of borrower default on the SEM loan; and
(7) the risk of borrower default on the traditional interest-bearing home loan that ranks ahead of the SEM loan.

### Genesis of the Invention

It should be clear from the exposition above that a new and entirely unprecedented range of insurance arrangements are required to enable the mass market distribution of shared equity mortgages and like instruments to consumers on a subordinated basis (ie, junior to the senior ranking interest-bearing home loans).

It can also be seen that these new insurance arrangements could be used to protect lenders and investors from a suite of previously unanticipated risks that do not otherwise exist in modern mortgage markets.

### SUMMARY OF THE INVENTION

In accordance with a first aspect of the present invention there is disclosed a method of generating a digitally encoded electric signal which represents an insurance premium to be paid in respect of a shared equity mortgage which ranks behind an interest bearing first mortgage, said method comprising the steps of:
a. inputting into a data store of a computing apparatus shared equity loan application data including the loan to valuation ratio of the shared equity mortgage to be insured, and the terms and loan to valuation ratio of said first mortgage,
b. inputting into said data store property data relating to the single property in respect of which both said mortgages are to be secured,
c. utilizing said stored property data to estimate a future sale price at predetermined future times in the event that said single property is to be sold at each of said predetermined future times,
d. utilizing said estimated future sale price at each of said predetermined future times to estimate a corresponding profit or loss of said shared equity mortgage in the event it is terminated at each of said predetermined future times, and
e. utilizing said estimated losses to calculate said insurance premium.

In accordance with a second aspect of the present invention there is also disclosed a system for generating a digitally encoded electric signal which represents an insurance premium to be paid in respect of a shared equity mortgage which ranks behind an interest bearing first mortgage, said system comprising:
(i) a computing apparatus having an data store and manipulation means to manipulate the data input into said store,
(ii) sale price estimation means incorporated in said computing apparatus to estimate a future sale price of a single property, in respect of which both said mortgages are to be secured, at predetermined future times in the event that said single property is to be sold at each of said predetermined future times,
(iii) profit and loss calculation means incorporated in said computing apparatus to calculate the profit or loss arising from any termination of said shared equity mortgage at each of said predetermined future times, and
(iv) premium calculation means incorporated in said computing apparatus to calculate said premium using any loss or losses calculated by said profit or loss calculation means.

### BRIEF DESCRIPTION OF THE DRAWINGS

An embodiment of the present invention will now be described with reference to the drawings in which:

FIG. 1 is a flow chart illustrating the operation of a conventional mortgage market,

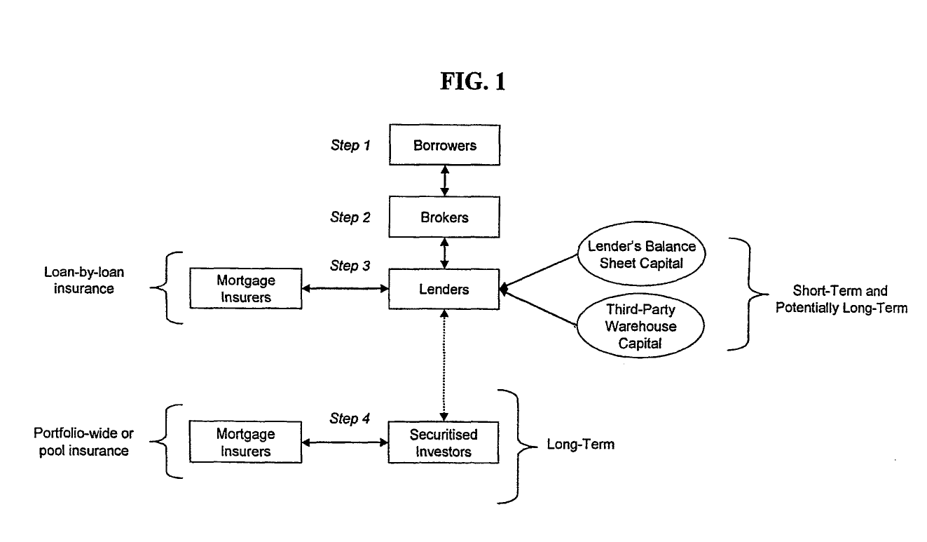

FIG. 2 is a block diagram illustrating the components of a Shared Equity Mortgage Insurance System (SEMIS),

FIG. 3 is a block diagram of a computer system upon which the methods and systems of the preferred embodiments can be implemented, and

FIG. 4 is a graph of a representative digitally encoded electric or electronic signal.

### DETAILED DESCRIPTION

The multi-tiered novelty underpinning the unique shared equity mortgage insurance (SEMI) class of products, which includes, but is not limited to:
(1) Unique state-dependent shared equity financing products combined with;
(2) The synergistic subordination of the shared equity instrument to a traditional mortgage product; and
(3) A distinctive class of risks that are peculiar to shared equity instruments,
   in turn demands a dynamic set of technologies, systems and methods to process loan application data, measure and quantify shared equity risks, price premiums using new and novel risk pricing algorithms, and ultimately provide SEMI decision making back to the front-end users.

### A. Overview According to One Embodiment

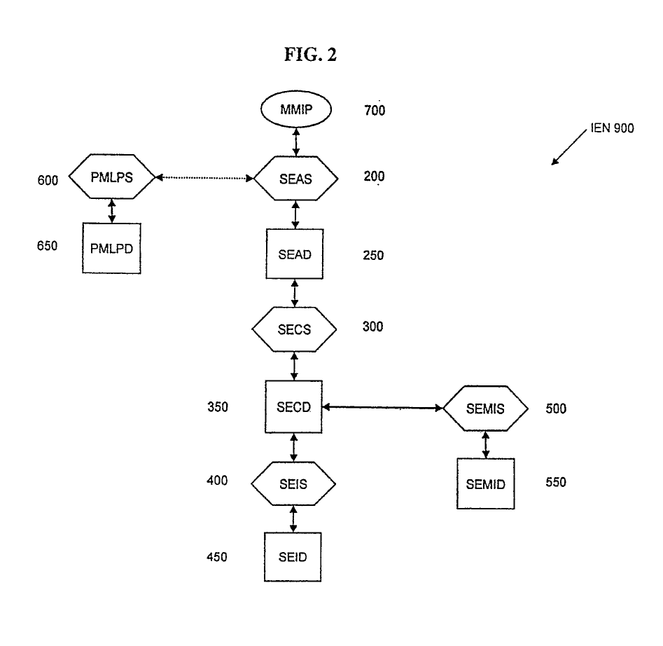

The Shared Equity Mortgage Insurance System (SEMIS) 500 illustrated in FIG. 2 interfaces with a number of modules connected via an Integrated Electronic Network (IEN) 900, which can function on a real-time, automated basis in order to process consumer application data and output SEMI data.

It should be noted that each of the individual systems that sit within the IEN 900 could, in theory, operate on an autonomous basis to process different functions, although they must electronically interface with one another in order to manage loan application data, score risks, compute premiums and deliver SEMI data.

The principal objective of SEMIS 500 is to electronically process Consumer Loan Application Data (CLAD) 100 (including detailed credit data and other information relating to characteristics of the underlying collateral asset) in order to make a real-time decision as to whether to offer SEMI insurance on the shared equity loan in question and, if so, on what specific terms and conditions (in particular, the premium pricing).

The constituent systems that interface with the SEMIS 500 include, but need not be limited to, the following:
1) a Shared Equity Application System (SEAS) 200;
2) a Shared Equity Credit System (SECS) 300;
3) a Shared Equity Investment System (SEIS) 400; and potentially
4) a Prime Mortgage Loan Processing System (PMLPS) 600.

In describing these systems and their relevant interfaces it is useful to also try and identify the commercial parties that benefit from them so as to facilitate comprehension. References to these parties should not be necessarily confused with any form of human intervention since the overall IEN 900 operates on an automated basis from the moment loan application data is entered into the SEAS 200 until the point where a final decision in relation to both the provision of the SEM and the SEMI (including their respective terms and conditions) is communicated to the front-end user.

The SEAS 200 receives shared equity loan application data inputted by Mortgage Market Information Providers (MMIPs) 700, which are typically mortgage brokers, financial advisors, or bank branch officers, including, but not limited to:
1) the applicant's age;
2) the applicant's income;
3) the applicant's employment history;
4) the applicant's previous employment history
5) the applicant's current residential address;
6) the applicant's assets and liabilities;
7) the SEM loan to value ratio (LVR);
8) the first-ranking interest-bearing mortgage LVR;
9) the first-ranking mortgage type (ie, interest rate, terms etc)
10) the property type (including number of bedrooms, bathrooms, etc);
11) the property location; and
12) Any other relevant data.

This data is processed into a standardized digital format and then stored into the Shared Equity Application Database (SEAD) 250. Once the data is recorded a signal is sent by the SEAS 500 to the SECS 300, so as to allow the shared equity lender to process the loan application data for credit appraisal. Alternatively, a signal can be sent to the SEMIS 500 (and therefore the SEMI provider) for risk appraisal and decision making in relation to the SEMI availability and premium pricing in advance of the SECS 300 processing.

In this regard, it is worthwhile highlighting that the IEN 900 can be configured in a multiplicity of ways given the modular nature of the underlying systems, which will be apparent to those expert in the art of loan processing technology. As one alternative, the data stored in the SEAD 250 can be utilized first by the SEMIS 500 in order for it to measure and quantify all of the shared equity loan risks, make decisions in relation to the insurance availability, and price the premiums as appropriate using a variety of algorithms, the functional form of which is described in the Premium Pricing section below. The outputs of the SEMIS 500 decision making can then be communicated back to the SEAS 200 and stored in the SEAD 250.

Upon recording the SEMIS 500 data output in the SEAD 250, the SECS 300 is notified that fresh application data combined with the SEMIS 500 output had been stored in the SEAD 250 for processing by the SECS 300. In this way, the SECS 300 can extract a single batch of consumer data and risk information and, upon appropriate processing of that data through the SECS 300's credit scorecard (ie, the decision rules system via which the SECS 300 processes a shared equity application), make a final decision as to whether to approve or reject the loan.

An alternative option to the sequencing described above is for the SEMIS 500 insurance decision making to be embedded into (or processed in parallel with) the SECS 300 scorecard. This is illustrated in FIG. 2 above. Practically put, this means that the SECS 300 processes the SEAD 250 data and, at the appropriate juncture in the SECS 300 credit decision-tree, sends the relevant application data to the SEMIS 500 in order for it to output its insurance information. Once the SEMIS 500 has processed the SECD 350 data it received and outputted its decision, this is stored in the SECD 350 for the SECS 300 to collect and process in order for it to continue progressing through its own decision-tree.

If the SEMIS 500 had outputted a positive insurance decision, the SECS 300 continue processing the application data through its own credit rules until an approval or rejection decision is reached. If, on the other hand, the SEMIS 500 outputted a negative decision, this information in turn triggers a rule failure within the SECS 300 credit scorecard and therefore an overall application failure. This data is stored in both the SECD 350 and communicated back to the SEAS 200 in order to inform the front-end user (ie. The Mortgage Market Information Provider MMIP 700).

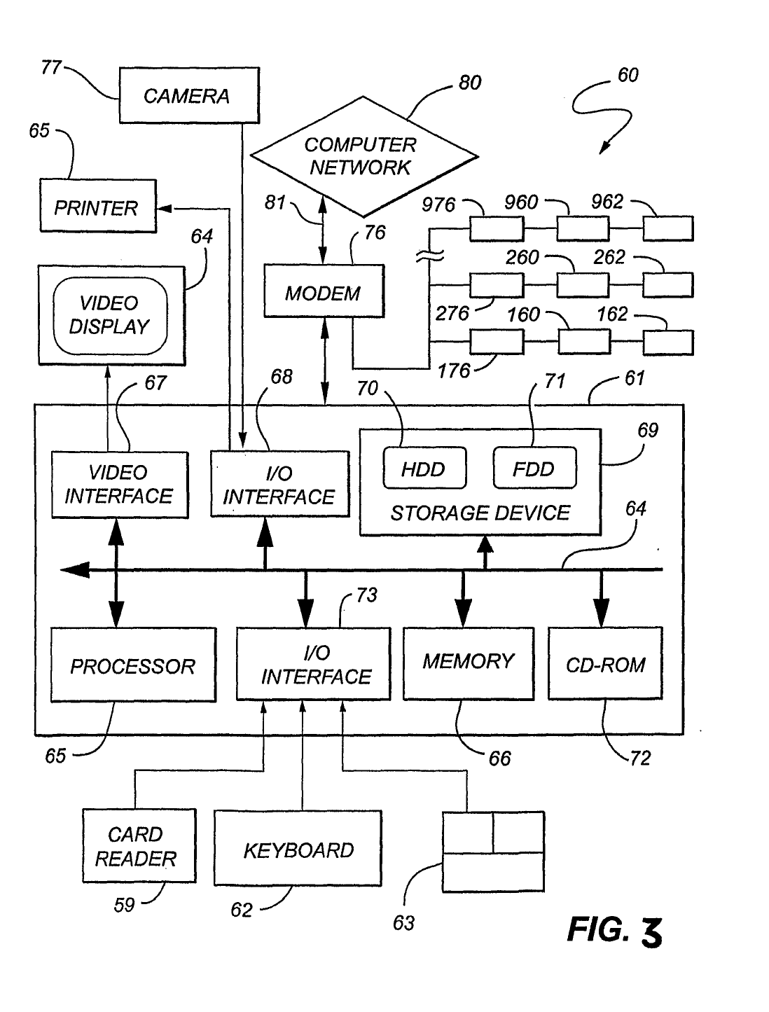

The methods and processes described above in relation to FIG. 2 are preferably practised using a conventional general-purpose computer system 60, such as that shown FIG. 3 wherein the processes are implemented as software, such as an application program executed within the computer system 60. In particular, the steps of the processes are effected by instructions in the software that are carried out by the computer. The software can be divided into two separate parts; one part for carrying out the specific processes; and another part to manage the user interface between the latter and the user. The software is able to be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer results in an advantageous apparatus for carrying out embodiments of the invention.

The computer system 60 comprises a computer module 61, input devices such as a keyboard 62 and mouse 63, output devices including a printer 65 and a display device 64. A Modulator-Demodulator (Modem) transceiver 76 is used by the computer module 61 for communicating to and from a communications network 80, for example connectable via a telephone line 81 or other functional medium. The modem 76 can be used to obtain access to the Internet, and other network systems, such as a Local Area Network (LAN) or a Wide Area Network (WAN) or other computers 160, 260, . . . 960, etc each with their own corresponding modem 176, 276, . . . 976, etc and each having a data input terminal 162, 262, . . . 962, etc. Each of the computers 160-960 are used to collect data by the front end user MMIP 700.

The computer module 61 typically includes at least one processor unit 65, a memory unit 66, for example formed from semiconductor random access memory (RAM) and read only memory (ROM). There are input/output (I/O) interfaces including a video interface 67, and an I/O interface 73 for the keyboard 62, mouse 63 and optionally a card reader 59, and a further interface 68 for the printer 65 or optionally a camera 77. A storage device 69 is provided and typically includes a hard disk drive 70 and a floppy disk drive 71. A magnetic tape drive (not illustrated) can also be used. A CD-ROM drive 72 is typically provided as a non-volatile source of data. The components 65 to 73 of the computer module 61, typically communicate via an interconnected bus 64 and in a manner which results in a conventional mode of operation of the computer system 60 known to those in the relevant art. Examples of computers on which the embodiments can be practiced include IBM-PC's and compatibles, Sun Sparcstations or a like computer systems evolved therefrom.

Typically, the application program of the preferred embodiment is resident on the hard disk drive 70 and read and controlled in its execution by the processor 65. Intermediate storage of the program and any data from the network 80 is accomplished using the semiconductor memory 66, possibly in concert with the hard disk drive 70. In some instances, the application program is encoded on a CD-ROM or floppy disk and read via the corresponding drive 72 or 71, or alternatively is read from the network 80 via the modem device 76. Still further, the software can also be loaded into the computer system 60 from other computer readable media including magnetic tape, a ROM or integrated circuit, a magneto-optical disk, a radio or infra-red transmission channel between the computer module 61 and another device, a computer readable card such as a PCMCIA card, and the Internet and Intranets including email transmissions and information recorded on websites and the like. The foregoing is merely exemplary of relevant computer readable media. Other computer readable media may be practiced without departing from the scope and spirit of the invention.

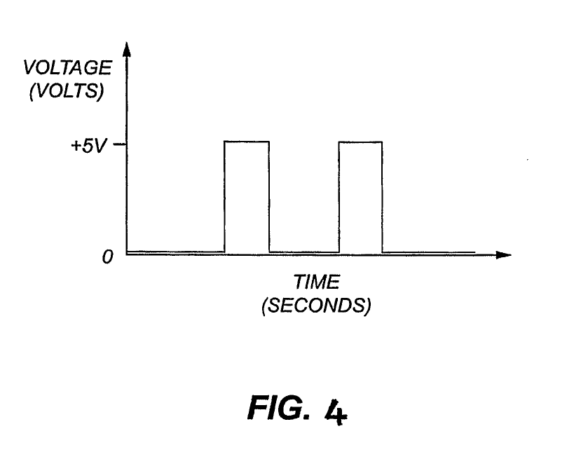

It should not be lost sight of that the purpose of the computer system 60 is to generate a digitally encoded electric signal (such as that illustrated in FIG. 4) which when applied to an output interface (such as the display device 64 or the printer 65) produces an indicium or indicia which convey information and which are legible or intelligible to a human. For example, the electric signal illustrated in FIG. 4 is a binary encoded signal 01001 which when applied to the display device 64 or printer 65 causes the indicium 9 to be displayed or printed.

The processes can alternatively be implemented in dedicated hardware such as one or more integrated circuits performing the functions or sub functions of the processes. Such dedicated hardware can include graphic processors, digital signal processors, or one or more microprocessors and associated memories.

The process of FIG. 2 is implemented by the computer system of FIG. 3. Generally, the local storage device 69 stores a software program to with all of the technologies, systems, methods and algorithms required to deliver the SEMI decision making. Such a software program is written in any desired programming language, such as C++ or Java. In addition, the software program is able to be located at a remote server across the Internet or over a dedicated line (not shown). Further, the process of FIG. 2 can be implemented in hardware or firmware. The inputs to the computer system are the SEM loan application data referred to above. The output of the computer system is the SEMI decision making and associated parameters (such as the premium pricing).

### A. Semi Premium Pricing

### A1. Background

For contextual purposes, it is useful to articulate the fundamental economic relationships that the shared equity insurer faces. These include: (1) the present value (PV) of the future insurance claim losses; (2) the PV of the projected SEMI premiums; and (3) the net expected insurance liability.

More specifically, the PV of the total expected shared equity mortgage insurance claim losses (PVSEMIL) can be represented in a generalized form as:

$$PVSEMIL = {\sum }_{t = 1}^{T ( a )} [ \frac{{ESEMC}_{t} \times {q}_{a , t}}{{( 1 + i )}^{t}} ] , \qquad ( 1 )$$

where PVSEMIL is the PV of the expected share equity mortgage insurance claim loss at t=0; ESEMCₜ is the expected SEMI claim loss at time t and therefore equal to max{0, [(TAOₜ−Pₜ)·qₐ₊ₜ; TAOₜ is the total amount owing under the SEM at time t; Pₜ is the expected property value at time t and equal to Pₜ=Pₒ·(1+g)^{t}); q_{a,t} is the probability that the loan will be in default at age a+t; and i is the discount rate.

On the date that the SEM settles, the PV of the insurer's total projected SEMI premiums can be computed as follows:

$$PVSEMIP = {USEMIP}_{0} + {\sum }_{t = 1}^{T ( a )} [ \frac{{MSEMIP}_{t} \times {q}_{a , t}}{{( 1 + i )}^{t}} ] , \qquad ( 2 )$$

where PVSEMIP is the discounted PV of the expected SEMI premiums at t=0; USEM/P₀ is the upfront SEMI premium and MSEMIPₜ is its ongoing monthly equivalent to the extent that the premium payments are structured in this manner.

With the above identities defined, the shared equity mortgage insurer's expected liability (ESEMIL) can be calculated as follows:

ESEMIL=PVSEMIL−(RESERVE+PVSEMIP), (3)

where ESEMIL is the net expected SEMI liability; RESERVE is the net reserve equal to Σₜ₋₁^{d}[(TIPₜ−TCₜ)(1+i)^{n-t}]; TIPₜ is the total value of the insurance premiums; TCₜ is the total value of the claim disbursements; d is the loan duration; and n is the number of months between the settlement of the loan and the cut-off date.

The SEMIS 500 process a wide array of consumer data, including but not limited to, information pertaining to the borrower's income, credit history, employment and extensive details of the underlying residential property asset, in order to compute an overall Shared Equity Risk Score (SERS). The SERS is in turn used to determine whether SEMIS 500 will accept or reject the application for insurance outright and, to the extent that the application is accepted, as one input into the SEMI premium pricing model.

### A2. SEMI Premium Pricing

This section describes the strategies to be adopted for deciding SEMI premium pricing. It begins with an overview of the issues and then develops a mathematical description of the SEMI premium pricing problem and one embodiment of its solution, including a description of how the computations are carried out.

### SEMI Premium Setting Principles

The premium for a particular risk or class of risks at a particular time may be regarded as consisting of:
a pure risk premium;
a safety loading, and
a loading for expenses.

It may be applied globally or within a segment of the SEM loan portfolio.

The pure risk premium takes into account the expected claims, the safety loading takes account of the margin that is required to allow for uncertainty (principally in the pure risk premium, but it may allow for other uncertainties too) and the loading for expenses includes expenses incurred in running the business, and items such as dividends to the shareholder. (Hence profit is included in this item.)

The premium actually charged (for a particular risk or class of risks at a particular time) will then be the sum of these items.

### Breakdown of Premiums by Portfolio Segment

The above concepts apply at a portfolio-aggregate level and can also be applied at a lower level, such as within a SEM LVR-band. The segments used for pricing are chosen with regard to:
risk factors, as identified by actuarial and statistical analysis;
product type, i.e. the type of SEM loan insured;
LVR-bands relevant for the calculation of the Minimum Capital Requirement.

### Pure Risk Premium

The pure risk premium is simply the expected (in the mathematical sense of average, mean or expectation) loss due to claims pay-out averaged over all SEM loans in the particular risk category at a particular time. The pure risk premium can thus be thought of as the break-even premium for the risk category in the absence of any expenses and without allowing any margin for safety to protect against statistical uncertainty. It is estimated typically by a (possibly weighted) historical average taken over the risk category.

The pure risk premium within a segment is determined by statistical analysis. This analysis will include analysis by actuaries as well as other business analysis.

### Discounting and Market Considerations

There is no requirement for premiums to be the same in two market segments, even if they have identical risks. Market considerations can be taken into account when setting the premiums in any particular segment. Thus, it is not necessary for the premium in a segment to be adequate to meet the claims expected to arise in that segment, provided there is adequate compensation (ie, a cross-subsidy) to be obtained elsewhere in the business. Generally, it will be the case that premiums will be set at a level adequate to cover the expected loss in each category, plus an appropriate safety factor for uncertainty. (The intention of this paragraph is that loss-incurring business “be identified and the loss quantified and recognised.”)

### Safety Factor for Uncertainty

The safety factor is applied at a portfolio-level of aggregation, although it can also be worked out as part of the analysis for individual segments.

At the portfolio level, the amount of capital held must be high enough to guarantee the company meets the Minimum Capital Requirement of the relevant regulator, which in Australia is APRA, so the premium needs to be high enough to enable this requirement to be maintained.

Choice of an appropriate safety factor requires in addition that the business specify a degree of safety (called level of sufficiency, below) or an appetite for risk. Further, the safety factor should be set at a level which enables the company to maintain or improve its ratings.

### Expenses

Expenses are generally estimated at the portfolio level, although they can be allocated to segments for analysis purposes.

Since expenses can be taken to include profit, analysis of the profit by segment can also be taken into account in setting premiums in individual segments.

### Reinsurance

It is assumed that the strategy of the company is to use reinsurance as a protection against excessive or catastrophic claims, so that the value of claims met by reinsurance is not generally used to determine premium. The cost of reinsurance is included in the expenses, however.

### Determination of SEMI Pure Risk Premium

### The Losses Insured Against

Losses (and profits) are realized on an SEM only if the loan is terminated. The SEM loan is terminated through any of the following actions:
1. Discharge at the end of the SEM term, or through the borrower exercising the right to terminate the SEM loan by selling the property;
2. Discharge without selling in order to refinance;
3. Default of the borrower under the terms of the SEM loan; and
4. Default of the borrower under the terms of the first mortgage.

These events are termed “terminations”.

In the first of these cases, a (nominal) loss is realized if the property is sold or the end of the term has been reached and the price obtained for the property is less than the price originally paid. In the second case, under the terms of the SEM, refinancing without selling the property requires the loan to be repaid in full, without an allowance for depreciation, so a loss is incurred only if the borrower does not make this payment (which is therefore a default and the third case applies). In the other two cases, a loss is realized if the value of the collateral is insufficient to repay the money lent, after the first mortgagee's claims have been met.

Traditionally, LMI has been insurance only against the borrower defaulting (that is, a credit event). The size of any LMI claim is the difference between the return from sale of the collateral, after costs have been met and the amount of loan outstanding. There is a claim if the return is not large enough to enable the loan to be repaid in full. Thus the assessment of losses of this type involves elements of both credit risk and market risk. In particular, the probability of default has traditionally been assessed through standard credit risk models.

The early discharge scenario, which affects the SEM only, has a component mostly of market risk.

### Estimation of Claim Size Distribution

An important part of the determination of the size of the loss in the event of termination in both loss scenarios is the estimation of the current market value of the properties over which a mortgage is held.

Consider a property with these amounts outstanding at the time of termination:
F, a standard loan from the first mortgagee and
S, an SEM, the second-ranking mortgagee.

The value of F is the current principal owing, since the loan is a conventional loan.

The amount S is the original amount lent under the SEM less any applicable allowance for depreciation (or plus any allowance for appreciation). No allowance for depreciation is made in the refinancing or default scenarios, but if it is required to insure against market risk, then in this case S is the amount lent, less the allowance for depreciation. It is the amount recoverable.

### The Claim Size

Since the economic cost to the SEM lender, ie taking into account the time-value of money, is not the amount recoverable, the lender makes a loss if the amount recovered from the borrower or the sale of the collateral is less than 5*, which is the value that would have been obtained if S had been invested in a savings account at the risk-free rate for the duration of the loan.

Depending on the details of the policy, a claim may arise from such a termination event if the price P at which the property sells, less the costs C of sale, less the payout of the first mortgage, is less than S*.

Thus to forecast the claim size distribution it is necessary to forecast the distribution of the price P. (It is likely to be the case that the costs C can be modelled realistically as a fixed proportion of the sale price.) Note that this has to be done for the properties that terminate: it is likely that the terminating properties will be different from the others, a relationship that can be discovered through statistical analysis, or, in the absence of directly relevant data, through the modelling assumptions. Note that a margin of error for model uncertainty will have to be included in the safety loading.

Forecasts of the selling prices of properties in a given future time period can be obtained in the following way, for each of the relevant portfolio segments:
1. Use an Automated Valuation Model (AVM) to estimate the value of the property in relation to similar properties (ie in the portfolio segment);
2. Use the forecasting model relevant to the market segment (and based on the known “hedonic” property price indices and associated econometric models) to predict the hedonic index value for the segment, at appropriate times in the future;
3. Apply the AVM using the predicted index value as an input to predict a value for each property in the portfolio segment.

### Claim Amount on Termination in Detail

Consider a SEM loan which has the following characteristics (defined below) at termination:
the principal outstanding on the first mortgage is F;
the amount lent under the SEM is K₀;
the amount recoverable under the SEM is K₁;
the economic value of the amount lent is K; and
the cost of recovering the amount owing is C.

The principal outstanding on the first mortgage is calculated by whatever means is appropriate for that mortgage; only the final value is relevant for our purposes.

The amount lent is the nominal amount lent at the start of the SEM. The amount recoverable is K₀, together with any allowance for depreciation. The allowance for depreciation depends on the type of termination: the value of K₀ may be less than, equal to, or greater than K₀. It is the amount owed by the borrower to the SEM lender.

The economic value of the amount lent is the value at the time of termination of an investment of K₀, made at the time the SEM loan was made, in a savings account which pays interest at the rate agreed in the insurance contract (such as the risk-free rate or the lender's cost of funds, or 0, if there is no insurance of economic loss, in which case K=K₀). It is also possible to have K=K₁, depending on the (optional) details of the policy.

If the termination occurs upon sale of the property, for a price P, then after the first mortgagee has been paid out, the amount available to the SEM mortgagee is

R=max(0,P−C−F), [equation (1)]

so the amount of a claim, X, in this notation is given by:

X=max(K−R,0). [equation (2)]

(So X is 0 if R>K and Hence in this Case there is No Loss.)

In the event that the property is not sold, P is set equal to zero.

If the borrower is in default of the SEM conditions and the property is not sold, then P−C is the amount recovered by legal action or other means. Such cases are likely to be rare and in any case will have to be analysed separately, as they do not involve the value of the collateral. The analysis below depends crucially on the value of the collateral.

### Relationship of Premium to Property Values

The premium is of course decided in advance. This means that the value of the collateral at termination (P in equation (1)) is not known at the time at which the premium is paid, and thus the premium has to be decided on the basis of forecast values.

### Distribution of Claim Amount

The claim amount is treated in this section as a random variable. The analysis below is carried out for a homogeneous segment of the portfolio.

In particular, it is assumed that there is a method for predicting the selling prices of properties in the portfolio, based on statistical analysis. It is based on an Automatic Valuation Model (AVM) for the segment, which gives an estimate of the value of a property in the segment given hedonic information (individual characteristics of the property) and the value of a hedonic (or other appropriate) index for the prices of the properties in the population from which the segment is drawn. The AVM provides information about the individual property, while information about the economic conditions obtaining at the time of termination is captured in the hedonic index; the hedonic index value used is itself a prediction from econometric models. The AVM can also contain a term which models the discount expected for mortgagee sales, if this applies in the cases concerned.

In symbols, then, the AVM provides a generalized additive model, with this sort of generic equation:

$$T ( P ) = {β}_{0} + {\sum }_{i = 1}^{p} {f}_{i} ( {Z}_{i}^{t} ) + {f}_{H} ( {H}_{t} ) + {β}_{D} ( D ) + ɛ , \qquad [ equation ( 3 ) ]$$

where P is the price at time t,T is an appropriate transformation of price (such as log), chosen to make the variance as homogeneous as possible, with good linearity and gaussian error distribution, if possible. The variables Zᵢ^{t}, i=1, . . . , p, are the hedonic characteristics of the property at time t (these may be vectors and one of them will be t), fᵢ are the estimated transformations of the variables. The particular variables Hₜ and D, the hedonic index at time t and a dummy for distressed sale, have corresponding transform f_{H} and coefficient β_{D}. Finally β₀ is a constant (which could be included in T, and ε is a mean zero random variable, with distribution denoted by F. In practice transformations T, fᵢ can be found so that ε has variance homogeneous across the segment, and is approximately gaussian. It is a modelling assumption that the εs for separate properties are independent. No evidence against this assumption has been found.

The preferred transformation, AVM and index are those disclosed in the present applicant's co-pending Australian Patent Application No. 2008 2 . . . (previously Application No. 2007 900 955) the contents of which are hereby incorporated into the present specification for all purposes.

The claim amount given termination is obtained by applying equations (1), (6) and (7) and is therefore a random variable.

To simulate this random variable, in order to compute the mean claim size at time t for example for a segment of the portfolio, equation (3) is applied for each property in the segment by drawing a random number ε* from the distribution F and then taking as the predicted value P* of the property at time t the inverse transformed price:

$${P}^{*} = {T}^{- 1} ( {β}_{0} + {\sum }_{i = 1}^{p} {f}_{i} ( {Z}_{i}^{t} ) + {f}_{H} ( {H}_{t} ) + {β}_{D} ( D ) + {ɛ}^{*} ) , \qquad [ equation ( 4 ) ]$$

where the values of the variables on the right hand side are of course those applying for the property at time t, and Hₜ is the predicted index value at time t for the segment.

### Forecasting Loss

To obtain estimates of the losses in a given future time period, the following Monte Carlo simulation strategy is employed:
1. Use the statistical models developed for probability of termination as a function of age of loan, econometric factors and other relevant factors to determine for each property the probability of termination in that time period, given it has not already terminated;
2. For each property in the portfolio determine by random draw from the appropriate distribution whether the property has terminated;
3. For the terminating properties in step 2 determine the size of the claim (if any) that would arise, using the forecast value of the property. Add up all the claim amounts;
4. Repeat the above process sufficiently often to ensure sampling variability is at an acceptable level.

Note that the statistical variability in the forecast property values will need to be accounted for.

This process enables the loss in any future time period to be estimated.

The total pure risk premium for all SEM loans in a segment is therefore the net PV of the sum of the losses in each future period, for that segment. The pure premium for an individual SEM loan is the total divided by the number of SEM loans in the segment.

### Specific Computational Strategies

In practice, Monte Carlo simulation is the best method for determining the premium. This method obviates the need to make assumptions about the homogeneity of the portfolio segment for which the premium is calculated, and avoids some of the approximations which are needed for any explicit analytic calculation. Nonetheless it is useful to have explicit expressions for the premiums, so this is done next. The results so obtained may in practice also be quite accurate, the accuracy depending on properties of the portfolio segment in question.

### Explicit Expressions for the Pure Risk Premium in the Next Period

Consider a homogeneous segment of the loan portfolio. Suppose it is desired to compute the pure risk premium for the next period, given the information available now, the beginning of the next period. At this time, for each k=1, . . . , K−1, the loans which are at risk and of age k are known. The number of such loans is denoted by Lₖ. The subscript k runs from 1 rather than 0 because the loans of age 1 at the beginning of the next period are those which came on risk in the preceding period.

The loans which will be of age 0 in the next period are not yet known. Therefore the number of such loans will be a random number, denoted by N, which is assumed to have a Poisson distribution with mean v.

It is assumed that the portfolio segment is sufficiently homogeneous that the probability that a loan of age k generates a loss, and hence a claim, in the next period is the same, δₖ, for all loans of age k, and that the loss (i.e. the claim size) is the same for all loans of age k, and is equal to ζₖ.

Denote by Dₖ the number of loans of age k which generate a loss, and hence a claim, in the next period. Then Dₖ is a random number, which can be taken to have a binomial distribution with parameters Lₖ and δₖ. (This assumes that given the present situation the loans behave independently; in particular, one loan generating a claim does not affect the chance of another doing so.) With these assumptions and the homogeneity of the segment, the total claim amount in the next period is the random variable

$$G = {\sum }_{k = 1}^{K - 1} {D}_{k} {ξ}_{k} . \qquad [ equation ( 5 ) ]$$

Given this information, if the size of the premium (per loan) is p, then the surplus W at the end of the next period will be the premium income less the total claim amount:

W=pN−G. [equation (6)]

The premium will be adequate if W≧0, so that it is not necessary to draw on the reserves to meet claims in the next period.

The pure risk premium is the premium which balances the expected income with the expected claim amount. That is,

$${p}_{pure} ν = {\sum }_{k = 1}^{K - 1} {L}_{k} {δ}_{k} {ξ}_{k} , \qquad [ equation ( 7 ) ]$$

since the expected value of Dₖ is Lₖδₖ.

In the long run this premium will be adequate to maintain reserves at their current level, but allowance must be made for the fact that W is a random variable and so fluctuations in the claim amount could annihilate the reserve, leading to ruin of the insurer. Therefore it is necessary to calculate a premium which has a safety loading.

Fix a number α, 0<α<1, the level of sufficiency. Then the premium is adequate with level of sufficiency a if

Pr(W>0)≧α. [equation (8)]

A typical value of α would be 75%.

To evaluate the probability, it is necessary to estimate the distribution of W. This is done by asymptotic approximation, assuming that the numbers of loans of each age are large enough to make the approximations below reasonable.

Since N is Poisson and the mean v is large, N is approximated by a Gaussian random variable with mean and variance both equal to v.

Each Dₖ, is approximated by a Gaussian random variable with mean Lₖδₖ and variance Lₖδₖ(1−δₖ).

Then from equation (6) it follows that W is the sum of independent approximately Gaussian random variables and is itself therefore approximately Gaussian. Write μ for the mean of W and let σ² be variance of W. Then

$$\begin{matrix}μ = p ν - γ , \\ where & [ equation ( 9 ) ] \\ γ = {\sum }_{k = 1}^{K - 1} {L}_{k} {δ}_{k} {ξ}_{k} , \\ and & [ equation ( 10 ) ] \\ {σ}^{2} = {p}^{2} ν + Q , \\ where & [ equation ( 11 ) ] \\ Q = {\sum }_{k = 1}^{K - 1} {L}_{k} {δ}_{k} ( 1 - {δ}_{k} ) {ξ}_{k}^{2} . & [ equation ( 12 ) ]\end{matrix}$$

For any u, let zᵤ denote the value such that, if Z is a standard normal random variable, the following holds:

Pr(Z≦zᵤ)=u. [equation (13)]

Then, if we set

$$Z = \frac{W - μ}{σ} ,$$

then the random variable Z is approximately standard normal, so the following must hold if p is to be sufficient at level α:

$$\begin{matrix}α = Pr ( W > 0 ) \\ = Pr ( \frac{W - μ}{σ} > - \frac{μ}{σ} ) \\ = Pr ( Z > - \frac{μ}{σ} ) \\ = 1 - Pr ( Z \leq - \frac{μ}{σ} )\end{matrix}$$

from which it follows that

$$Pr ( Z \leq - \frac{μ}{σ} ) = 1 - α$$

and hence

$$- \frac{μ}{σ} = {z}_{1 - α} .$$

Put ζ=−z_{1-α}, and obtain from this last equation:

μ²=ζ²σ²

or, equivalently,

(pv−y)²=ζ²(p²v+Q).

It follows, after expanding this and rearranging, that p must satisfy the quadratic equation:

(v²−ζ²v)p²−2vyp+γ²−ζ²Q=0.

The solutions of this equation are

$$\frac{- νγ \pm ζ \sqrt{ν ( ν - {ζ}^{2} ) Q + {νγ}^{2}}}{ν ( ν - {ζ}^{2} )} .$$

Since ζ² is very much smaller than v, these solutions are easily seen to be approximately

$$\begin{matrix}\frac{νγ \pm ζ \sqrt{{ν}^{2} Q + {νγ}^{2}}}{{ν}^{2}} = \frac{γ}{ν} \pm \frac{ζ}{{ν}^{2}} \sqrt{{ν}^{2} Q + {νγ}^{2}} \\ = {p}_{pure} \pm \frac{ζ}{{ν}^{2}} \sqrt{{ν}^{2} Q + {νγ}^{2}}\end{matrix}$$

and hence the correct solution is the one which is larger than pₚᵤᵣₑ. Noting that if α>0.5, then ζ>0, one finds that the premium with level of sufficiency α is p_{α}, where

$${p}_{α} = {p}_{pure} + \frac{ζ}{{ν}^{2}} \sqrt{{ν}^{2} Q + {νγ}^{2}} . \qquad [ equation ( 14 ) ]$$

This exhibits a specific formula for the premium sufficient at level a, for a homogeneous portfolio segment, for the next period, given the information available at the start of the period.

### Numerical Illustration

To illustrate the calculation with a numerical example, consider the calculation presented in the following worksheet, which represents a scenario in which the life of a loan is 10 years, the current number at risk is broken down by age in the third column, the probability of a claim is in the second column, the average loss is in the fourth column, and the expected total loss and variance broken down by age are in the columns shown. The value of a and the corresponding value of ζ are as shown, corresponding to a level of sufficiency of 75%. The number of new loans in the next period has mean v=1000. After the indicated calculations, the pure risk premium and premium sufficient at level 75% are found to be 13.8 and 15.1, respectively.

| | | Number | | Expected | |
|---|---|---|---|---|---|
| | | at risk, | Average | total loss by | Variance |
| Age, k | δₖ | Lₖ | loss, ξₖ | age | by age |
| 1 | 0.02 | 500 | 100 | 1000 | 98000 |
| 2 | 0.04 | 400 | 200 | 3200 | 614400 |
| 3 | 0.06 | 300 | 300 | 5400 | 1522800 |
| 4 | 0.04 | 100 | 300 | 1200 | 345600 |
| 5 | 0.02 | 100 | 300 | 600 | 176400 |
| 6 | 0.02 | 100 | 300 | 600 | 176400 |
| 7 | 0.02 | 100 | 300 | 600 | 176400 |
| 8 | 0.02 | 100 | 300 | 600 | 176400 |
| 9 | 0.02 | 100 | 300 | 600 | 176400 |

| | |
|---|---|
| γ | 13800 |
| Q | 3462800 |
| ν | 1000 |
| α | 0.75 |
| ζ | 0.6745 |
| ν²Q + νγ² | 3.65E+12 |
| pₚᵤᵣₑ | 13.8 |
| \sqrt{ν²Q + νγ²} | 1911345 |
| p_{α} | 15.1 |

Of course, the above numbers are illustrative only and have been simplified to assist in the comprehension of the example.

The foregoing describes only some embodiment(s) of the present invention and modifications, obvious to those skilled in the insurance premium calculation arts, can be made thereto without departing from the scope of the present invention.

The term “comprising” (and its grammatical variations) as used herein is used in the inclusive sense of “including” or “having” and not in the exclusive sense of “consisting only of”.

1. A method of generating a digitally encoded electric signal which represents an insurance premium to be paid in respect of a shared equity mortgage which ranks behind an interest bearing first mortgage, said method comprising the steps of:
(i) inputting into a data store of a computing apparatus shared equity loan application data including the loan to valuation ratio of the shared equity mortgage to be insured, and the terms and loan to valuation ratio of said first mortgage,
(ii) inputting into said data store property data relating to the single property in respect of which both said mortgages are to be secured,
(iii) utilizing said stored property data to estimate a future sale price at predetermined future times in the event that said single property is to be sold at each of said predetermined future times,
(iv) utilizing said estimated future sale price at each of said predetermined future times to estimate a corresponding profit or loss of said shared equity mortgage in the event it is terminated at each of said predetermined future times, and
(v) utilizing said estimated losses to calculate said insurance premium.

2. The method as claimed in claim 1 including the further steps of:
(vi) calculating a probability of loss at each of said predetermined future times, and
(vii) combining the losses estimated in step (iv) with the probabilities calculated in step
(vi) to calculate said insurance premium.

3. The method as claimed in claim 2 wherein step (vii) utilizes the equation
$${p}_{pure} ν = {\sum }_{k = 1}^{K - 1} {L}_{k} {δ}_{k} {ξ}_{k} .$$

4. The method as claimed in claim 2 wherein step (vii) utilizes the equation
$${p}_{α} = {p}_{pure} + \frac{ζ}{{ν}^{2}} \sqrt{{ν}^{2} Q + {νγ}^{2}} .$$

5. The method as claimed in claim 2 where in step (iv) to estimate said losses at said predetermined future times a Monte Carlo simulation is carried out.

6. The method as claimed in claim 5 wherein said Monte Carlo simulation comprises the steps of:
(viii) dividing a portfolio of shared equity mortgages into groups corresponding to each of said predetermined future times,
(ix) for each group selecting a random sample corresponding to a probability of termination at the corresponding future time, and for the selected fraction calculating the loss if the selected sample of mortgages had terminated at said corresponding future time,
(x) repeating step (ix) a number of times sufficient to reduce statistical variability and averaging the result, and
(xi) repeating step (ix) and (x) for each of said predetermined futures times.

7. The method as claimed in claim 6 including the step of:
(xii) in carrying out step (iii) using an automatic valuation model to estimate said future sale process.

8. The method as claimed in claim 7 wherein said automatic valuation model utilize a hedonic property index.

9. (canceled)

10. A system for generating a digitally encoded electric signal which represents an insurance premium to be paid in respect of a shared equity mortgage which ranks behind an interest bearing first mortgage, said system comprising:
(i) a computing apparatus having an data store and manipulation means to manipulate the data input into said store,
(ii) sale price estimation means incorporated in said computing apparatus to estimate a future sale price of a single property, in respect of which both said mortgages are to be secured, at predetermined future times in the event that said single property is to be sold at each of said predetermined future times,
(iii) profit and loss calculation means incorporated in said computing apparatus to calculate the profit or loss arising from any termination of said shared equity mortgage at each of said predetermined future times, and
premium calculation means incorporated in said computing apparatus to calculate said premium using any loss or losses calculated by said profit or loss calculation means.
